(19) United States
(12) Patent Application Publication
(10) Pub. No.: US 2022/0212879 A1
(43) Pub. Date: Jul. 7, 2022

(54) METHOD AND SYSTEM FOR MONITORING A CONVEYOR BELT

(71) Applicant: ATOMATION NET LTD., Tel Aviv (IL)

(72) Inventor: ERAN KESHET, TEL AVIV (IL)

(21) Appl. No.: 17/567,196

(22) Filed: Jan. 3, 2022

Related U.S. Application Data
(60) Provisional application No. 63/134,203, filed on Jan. 6, 2021.

(51) Int. Cl. B65G 43/00

(52) U.S. Cl. CPC B65G 43/00; B65G 2203/046; B65G 2203/043; B65G 2203/0291

(57) ABSTRACT

A system and method for monitoring a conveyor belt system, the monitoring system including a sensor unit having one or more sensors embedded in the belt of the conveyor belt, such that the one or more sensors collect motion measurements when the belt moves, and a processing unit for executing instructions for identifying an irregular measurement in the collected motion measurements and computing a location in the conveyor belt system in which the irregular measurement was measured.

### FIELD

The invention relates generally to the field of monitoring conveyor belts.

### BACKGROUND

Conveyors, such as a conveyor belts, are mainly used to transport products or persons from one point to another. Conveyors are used in manufacturing, logistic, or transport environments. Standard conveyor belts include a body, coupled to a surface such as a floor, an engine that moves the belt and the belt itself. In order to reduce the friction in the belt's motion, rollers may be placed between the body and the belt, such that belt is primarily in physical contact with the rollers. The rollers may cover the entire width of the belt, or just a portion of the belt's width.

As part of the conveyer's operation, parts of it such as the belt, rollers, engine may start to wear. Solutions to monitor the wear include capturing and analyzing images of the conveyor belt, which require installing a complicated and fairly expensive system. Other solutions, as disclosed in U.S. Pat. No. 9,227,791, disclose sensors embedded in the belt, that monitor accelerations in the belt's movement in the conveying direction. That solution also comprises a damper controlled by the controller to damp accelerations of the conveyor belt in the conveying direction in response to the measurements of the acceleration of the conveyor belt in the conveying direction.

There is a need for a monitoring system to detect failure, possible future failure and the location of the failure or the potentially failure causing area in the path of the belt, the belt itself or in the rollers of conveyor belt system, without the need of installing a complicated and expensive hardware.

### SUMMARY

In one aspect of the invention a monitoring system is provided for a conveyor belt system, the monitoring system including a sensor unit having one or more sensors embedded in the belt of the conveyor belt, such that the one or more sensors collect motion measurements when the belt moves, a processing unit for executing instructions for receiving the motion measurements collected by the sensor unit and identifying an irregular measurement in the collected motion measurements.

In some cases, the instructions also include computing a location in the conveyor belt system in which the irregular measurement was measured. In some cases, the sensor unit includes a magnetometer for collecting measurements of a magnetic field to identify the location of the sensor unit relative to the body of the conveyor belt system.

In some cases, the monitoring system further includes magnetic members coupled in various locations in the body of the conveyor belt system, where the magnetometer collects magnetic measurements of magnetic fields created by the magnetic members, where the processing unit computes a location of the irregular movements based on the magnetic measurements.

In some cases, the monitoring system further includes multiple RFID members coupled in various locations in the body of the conveyor belt system, and the sensor unit includes a RFID reader for collecting measurements of a wireless signal generated by the RFID members to identify the location of the sensor unit relative to the body of the conveyor belt system.

In some cases, the irregular measurement includes movement perpendicular to a surface level of the belt. In some cases, the processing unit resides in the one or more sensors. In some cases, the processing unit resides in a remote device communicating with the one or more sensors.

In some cases, the monitoring system further includes a wireless transmitter for transmitting information associated with the movements to a remote device. In some cases, the sensor unit includes an accelerometer for sensing acceleration in the belt's movement. In some cases, the sensor unit includes a Gyroscope.

In some cases, the processing unit includes instructions to send a signal to a drive member of the belt, the signal includes a command to stop the belt. In some cases, the processing unit includes instructions to gathering data for predictive analysis of the belt's movement. In some cases, the processing unit identifies irregular measurements by comparing the collected motion measurements with basic motion measurements.

In another aspect of the invention a computer implemented method is provided, including moving a conveyor belt having a sensor unit that moves when the conveyor belt moves, collecting motion measurements from the sensor unit, a significant difference between the collected motion measurements and the basic motion measurements, identifying an irregular motion in the conveyor belt. In some cases, the sensor unit includes a magnetometer for collecting measurements of a magnetic field to identify the location of the sensor unit relative to the body of the conveyor belt system.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method for monitoring movements of a conveyor belt, according to exemplary embodiments of the invention.

FIG. 2 shows a method for monitoring movements of a conveyor belt using magnetic members, according to exemplary embodiments of the invention.

FIG. 3 shows a schematic conveyor belt system coupled with a monitoring system, according to exemplary embodiments of the invention.

### DETAILED DESCRIPTION

The invention, in embodiments thereof, discloses a monitoring system and a monitoring method for monitoring operation of a conveyor belt system. More specifically, the monitoring system and method monitor the rollers or other mechanism on which the conveyor belt moves. The method also discloses monitoring the belt itself and the effects of the operation of the conveyor belt system as a whole (the belt, the rollers, the driving member of the belt etc.) on the belt's movement. The method also defines changes between the belt's movement when the conveyor belt system operates properly in comparison to the belt's movement when a problem is predicted or occurs as a result of wear and tear of parts in the conveyor belt system. For example, wear of the rollers results in small bumps or jumps or extra friction to the belt or change the angle in which the belt moves that may later damage the belt itself, or the goods transported on the belt. The technical solution disclosed herein is a sensor unit embedded in the belt for collecting motions angles of the belt, proximity and distance from predefined locations etc. As the standard operation of the conveyor belt includes motion in the conveyor direction, the sensor unit detects motion in all directions. For example, if the conveyor direction is the X axis and the width of the belt is the Y axis, the sensor unit may detect force in the Z axis. In some exemplary cases, the sensor unit also monitors motion information in the X axis and the Y axis in order to determine changes in behavior of the movement of the conveyor belt over time.

The sensor unit embedded in the conveyor belt may move in three dimensions—1. The conveying dimension, in which the conveyor belt advances. 2. The width dimension, defined between two sides of the conveyor belt. 3. The gravitation dimension, defined towards the ground.

The sensor unit may also measure tilts in the sensor unit's movement. In standard operation, the bottom side of the sensor unit faces the ground. When there is a movement around an imaginary axis in the width dimension, the sensor unit tilts and the measurements collected by the sensor changes. Such tilting is also defined as irregularity in the conveyor belt's movement. Another example—if the conveyor belt just moves in the width dimension because of a roller being stuck the sensor unit will also detect a shift to the Y axis, and will mark it as an irregularity.

The sensor unit may also include a wireless transmitter for transmitting information to a remote device, such as a processing unit located in the vicinity of the conveyor belt, or to a server located remotely, or to a web address (URL). The wireless transmitter may send the measurements taken by the sensor and the timestamp in which the measurements were taken. The sensors unit includes sensors that detects measurements of the sensor. The sensors unit may include an accelerometer, a gyroscope, magnetometer or any other sensor for measuring changes in the direction in all 3 directions. The sensor unit may either send the measurements using the wireless transmitter or store the measurements in a memory device, such that after movement, the measurements are collected or copied from the memory device, for example via a cable, or a device such as a memory stick.

The wireless transmitter may send signals using a wireless technique, such as blue-tooth, Wi-Fi, over a cellular network, WAN, Zig-Bee, and the like.

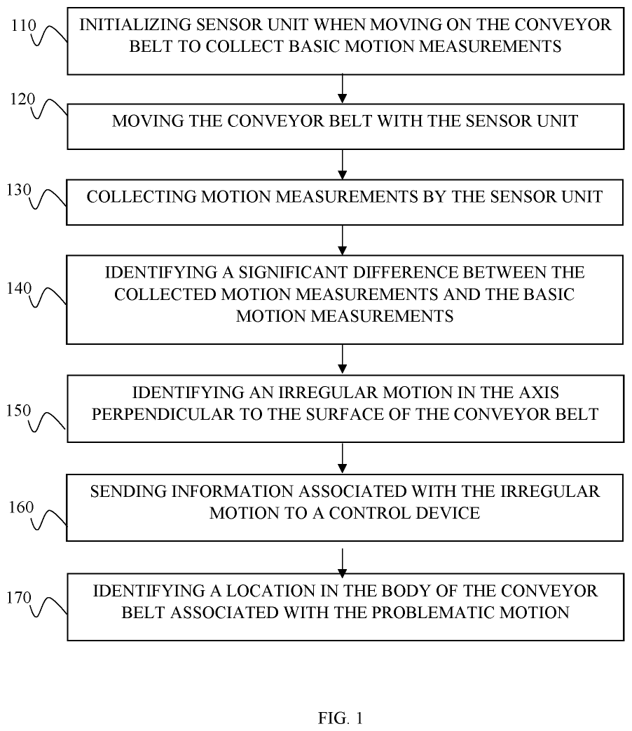

FIG. 1 shows a method for monitoring irregular movements of a conveyor belt, according to exemplary embodiments of the invention. The term perpendicular movements define any movement in a direction perpendicular to the surface of the belt, for example “outside from” or “towards” the volume surrounded by the conveyor belt. The term perpendicular movements can also be defined as movement in the Z axis, when the conveyor direction is the X axis and the width of the belt is the Y axis. In some cases, the method may also collect motion information in the Y axis.

Step 110 discloses initializing sensor unit when moving on the conveyor belt to collect basic motion measurements. The initialization process is optional, and the sensor unit may detect irregular movements or perpendicular movements based on a set of rules stored in a memory of the sensor unit or in the server by comparing and/or analyzing the data collected by the sensor unit. When performing the initialization process, the conveyor belt may move with the sensor unit embedded therein at least one loop, and the sensor unit detects whether there are any irregularities in the movement, such as bumps or jumps in the belt's movement or an angle of the belt which is different than the desired angle or different than a previous angle measured by the sensor. The irregularities may be in an axis perpendicular to the conveyor axis, mainly sideways or upwards. The sensor unit may also store the location of the bumps in the sensor memory or send the locations of the bumps to another device using the wireless transmitter or store and contain data which will enable computing the location of the irregularity.

Step 120 discloses moving conveyor belt with the sensor unit embedded therein. The sensor unit may be activated in a periodic manner. The term “embedded” is used in a broad sense to encompass any installation of a sensor unit in a conveyor. Examples of embedded sensor units include a sensor unit mounted on or in, molded into, inserted into, laminated in, welded to, bonded to, or otherwise rigidly connected to the advancing conveyor. The sensor unit may be embedded in the conveyor belt all the time, and be activated periodically, for example to extend the sensor's battery life. Example for such periodic activation may be activation for a whole loop of the belt twice a day, as the time duration of the loop varies based on the normal operation of the belt. This may also include installing multiple sensor units in a belt in order to gather data faster and more accurately.

Step 130 discloses collecting motion measurements by the sensor unit. The motion measurements may be collected by an accelerometer configured to detect motion in the Z axis. The sampling rate of the accelerometer may be defined by a person skilled in the art, for example between 100 and 10,000 samples per second. The sampling rate may be configured based on the belt's speed. The belt's angle can be calculated according to the acceleration value of the Z axis taking into consideration known values of the belt's movement and the gravitational pull towards the Z direction.

Another way may be to measure the movements in the Y direction and monitor their changes during the belt's movement and also to compare measure the movements in the Y direction to previous values at the same locations and deduct a change in the Y direction. These can tell on wear and tear in the belt/rollers/body/engine, and current or future possible failures in its operation. This can also determine the location of the problem associated with the irregular measurement.

Step 140 discloses identifying a significant difference between the collected motion measurements and the basic motion measurements. The basic motion measurements are the measurements collected during the initialization process. In case there is a difference in the motion measurements. The significant difference may be a change of 2 millimeters between the value of the initialization process and the new measurements, or any other value defined by a person skilled in the art.

Step 150 discloses identifying an irregular motion in the conveyor belt. The irregular motion may be identified in case the accelerometer or gyroscope measured a value which is higher than a predefined threshold. The irregular motion may be associated with a location. The location may be provided as world coordinates, or location along the conveyor belt, such as “bottom part of the belt, between rollers #13 and #14”. The location may be extracted from a time stamp of the motion measurements and extracting the location of the sensor unit that provided the motion measurement associated with the irregular motion. For example, the device extracting the location of the irregular motion stores the estimated location of the sensor unit in a given time. For example, if a full encirclement of the conveyor belt takes 20 seconds and the location of the sensor unit at time stamp 0:00:00 is known, the sensor unit's location can be computed in time stamp of 7.22 seconds.

Step 160 discloses sending information associated with the irregular motion to a control device. The information may be sent by a wireless transmitter of the sensor unit. In some other cases, an electronic device may be coupled to the memory of the sensor unit to extract the information via physical connectors. In some cases, the control device may stop of the conveyor belt based on the information sent from the sensor unit to the control device and relay these instructions to the belt's control mechanism directly or via a remote server.

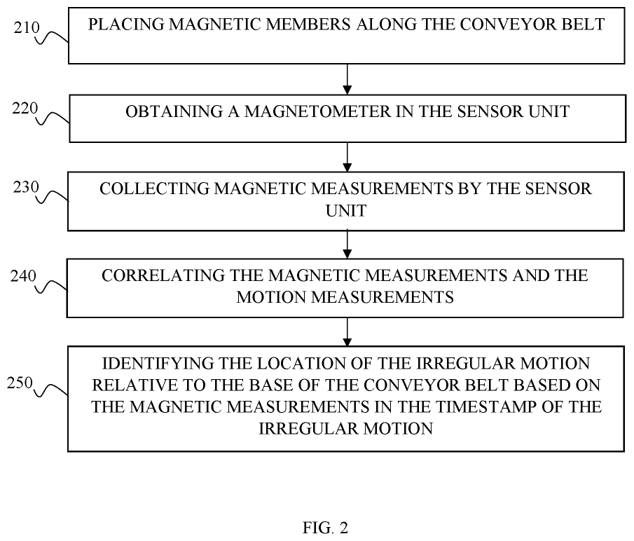

Step 170 discloses identifying a location in the body of the conveyor belt associated with the irregular motion. The location may imply a specific roller or another part that caused the irregular motion. The location may be extracted according to the timestamp of the motion measurement that resulted in the irregular motion. Irregularities in the belt's movement may also result in identifying a problem in the belt itself. For example, the one or more sensor units detect irregularities every time a problematic area in the belt is in physical contact with a roller. For example, once every 1.7 meters. Then, based on the timestamp of the collected measurement, or the collected values and a set of rules, the location of the problematic area in the belt can be computed. The problematic area may be defined as a torn area of the conveyor belt, less tensed area of the conveyor belt, holes or niches in the belt and the like. The location of the problematic area in the belt may be extracted by calculating the timestamp associated with the irregular motion measurement, the sensor's initial location and the belt's speed in the conveyor direction. In some other cases, the location may be identified using the magnetic members as disclosed in FIG. 2. In some other cases, the location of the sensor unit relative to the ground may be determined based on RFID units located in the conveyor belt systems. The sensor unit may include the reader or the tag, based on the design selected by the person skilled in the art. The exact location may be computed based on signal strength or by the time elapsed since the last signal and the location of the RFID unit with which the sensor unit had the last communication. The signal strength may refer to the signal sent from the sensor unit to the RFID unit, or to another transceiver placed on or nearby the conveyor belt.

FIG. 2 shows a method for monitoring movements of a conveyor belt using magnetic members, according to exemplary embodiments of the invention.

Step 210 discloses placing magnetic members along the conveyor belt, for example at the base of the belt. The magnetic members are placed in a fixed place, meaning that their location does not change when the conveyor belt moves in the conveyor direction. The magnetic members may be secured to rollers, or the floor or another fixed element located near the body of the conveyor belt system.

Step 220 discloses obtaining a magnetometer in the sensor unit. The magnetometer is configured to measures magnetic field or magnetic dipole moment. Some magnetometers measure the direction, strength, or relative change of a magnetic field at a particular location. The magnetometer is included in the sensor device in addition to the motion sensor, to identify the irregularity (e.g., bump) and its location. In some cases, the magnetometer may locate the movement irregularities by identifying when the belt is tilted the distance between the magnetometer and the magnet changes in a different way than the standard conveying movement, thus making the reading stronger or weaker. The magnetometer may also be used without magnet members and record the values along the path of the belt and monitor the change in the measured magnetic values over time to determine changes in the movement of the belt.

Step 230 discloses collecting magnetic measurements by the sensor unit. The magnetic measurements are collected by the magnetometer in a sampling rate defined by the designer of the monitoring system. In some cases, the magnetic measurements are deleted after some time, in case the motion sensor does not detect motion in the Z axis. If the motion sensor detects motion in the Z axis, perpendicular to the surface of the belt, the magnetic measurements and the motion measurements are correlated as disclosed below.

Step 240 discloses correlating the magnetic measurements and the motion measurements. Correlating the magnetic measurements and the motion measurements is performed based on the timestamp in which the sensors, either the motion sensor and the magnetometer, collected the measurements, respectively.

Step 250 discloses identifying the location of the irregular motion relative to the base of the conveyor belt based on the magnetic measurements in the timestamp of the irregular motion. The location may be identified based on the magnetic measurements collected by the multiple magnetic members. The processing unit stores the magnetic field applied by the magnetic members in multiple distances from the magnetometer. Hence, the processing unit may extrapolate the sensor's location based on the magnetic field applied on the magnetometer from the multiple magnetic members. For example, in case the total magnetic field measured is 1.2 Tesla, the processing unit can estimate that the sensor was in 4 optional points. Then, based on the timestamp, the processing unit can determine which of the 4 optional points, and determine the location of the bump in the determined location. The processing unit may then issue an alert with the determined location and send the alert to another device or destination, such as a server, email address, phone number and the like.

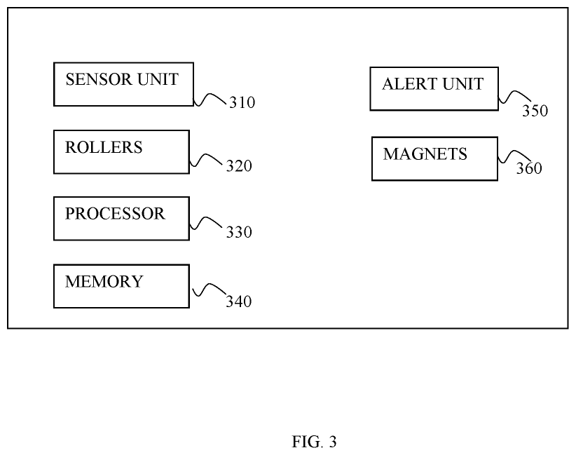

FIG. 3 shows a schematic conveyor belt system coupled with a monitoring system, according to exemplary embodiments of the invention.

The monitoring system includes a sensor unit 310 embedded into the belt of the conveyor belt system. The sensor unit 310 moves when the conveyor belt moves. The sensor unit includes a wireless transmitter for sending wireless signals to the processing unit, or processor 330, which processes the information collected by the sensor unit 310. The sensor unit 310 includes a motion sensor, for example an accelerometer or gyroscope. The sensor unit 310 may include a magnetometer for measuring a magnetic signal generated by the magnetic members 360.

The monitoring system includes rollers 320 located between the body of the conveyor belt system and the belt. The rollers 320 roll when the belt moves, to reduce the friction of the belt, and increase the belt's efficiency.

The monitoring system also includes a processor 330. The processor 330 may be a controller, a microprocessor, may be embedded in a personal mobile device such as a tablet or cellular phone. The processor 330 may execute software based on the measurements collected by the sensor unit 310.

The monitoring system also includes a memory 340 for storing the measurements collected by the sensor unit 310. The memory 340 may also store rules and processes used to process the measurements collected by the sensor unit 310. The memory may be implemented in hardware or software, and may be part of an electronic device or be part of a cloud storage services.

The monitoring system also includes an alert unit 350 for generating alerts in case the processor 330 identifies a problem in the rollers 320.

The monitoring system also includes magnets 360. The magnets 360, also defined above as magnetic members, may be secured to the body of the conveyor belt system, and generate magnetic fields. In case the sensor unit 310 includes a magnetometer, the magnetometer measures the magnetic fields. The magnetic measurements are converted to locations, for example based on tables or based on an algorithm which outputs the location or movement based on a series of magnetic measurements.

In some cases, the sensor unit 310 includes multiple sensor devices located in different places along the belt. For example, 10 sensor devices, each fully operational and including an accelerometer/magnetometer/gyroscope and a wireless transmitter, span every 30 meters in a belt of 300 meters. The multiple sensor devices may improve the accuracy of motion irregularities and the problem's location, for example by detecting a problem each time one of the sensor devices passes in a certain location and a certain behavior causes a certain measurement.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiments disclosed herein.

What is claimed is:

1. A monitoring system for a conveyor belt system, said monitoring system comprising:
a sensor unit having one or more sensors embedded in the belt of the conveyor belt, such that the one or more sensors collect motion measurements when the belt moves; and
a processing unit for executing instructions for
receiving the motion measurements collected by the sensor unit. and
identifying an irregular measurement in the collected motion measurements.

2. The monitoring system of claim 1, wherein the instructions also comprise computing a location in the conveyor belt system in which the irregular measurement was measured.

3. The monitoring system of claim 2, wherein the sensor unit comprises a magnetometer for collecting measurements of a magnetic field to identify the location of the sensor unit relative to the body of the conveyor belt system.

4. The monitoring system of claim 3, further comprises magnetic members coupled in various locations in the body of the conveyor belt system, wherein the magnetometer collects magnetic measurements of magnetic fields created by the magnetic members, wherein the processing unit computes a location of the irregular movements based on the magnetic measurements.

5. The monitoring system of claim 2, further comprises multiple RFID members coupled in various locations in the body of the conveyor belt system and the sensor unit comprises a RFID reader for collecting measurements of a wireless signal generated by the RFID members to identify the location of the sensor unit relative to the body of the conveyor belt system.

6. The monitoring system of claim 1, wherein the irregular measurement comprises movement perpendicular to a surface level of the belt.

7. The monitoring system of claim 1, wherein the processing unit resides in the one or more sensors.

8. The monitoring system of claim 1, wherein the processing unit resides in a remote device communicating with the one or more sensors.

9. The monitoring system of claim 1, further comprising a wireless transmitter for transmitting information associated with the movements to a remote device.

10. The monitoring system of claim 1, wherein the sensor unit comprises an accelerometer for sensing acceleration in the belt's movement.

11. The monitoring system of claim 1, wherein the sensor unit comprises a Gyroscope.

12. The monitoring system of claim 1, wherein the processing unit comprises instructions to send a signal to a drive member of the belt, said signal comprises a command to stop the belt.

13. The monitoring system of claim 1, wherein the processing unit comprises instructions to gathering data for predictive analysis of the belt's movement.

14. The monitoring system of claim 1, wherein the processing unit identifies irregular measurements by comparing the collected motion measurements with basic motion measurements.

15. A computer implemented method, comprising:
moving a conveyor belt having a sensor unit that moves when the conveyor belt moves;
collecting motion measurements from the sensor unit;
a significant difference between the collected motion measurements and the basic motion measurements;
identifying an irregular motion in the conveyor belt.

16. The method of claim 14, wherein the sensor unit comprises a magnetometer for collecting measurements of a magnetic field to identify the location of the sensor unit relative to the body of the conveyor belt system.
